(19) United States
(12) Patent Application Publication
(10) Pub. No.: US 2004/0074045 A1
(43) Pub. Date: Apr. 22, 2004

(54) Electrical connectivity through a hinge

(76) Inventors: Russell Winstead, Raleigh, NC (US); Charles Rudisill, Apex, NC (US)

Correspondence Address: BAKER & BOTTS, 30 ROCKEFELLER PLAZA, NEW YORK, NY, 10112

(21) Appl. No.: 10/277,582

(22) Filed: Oct. 22, 2002

(51) Int. Cl. H01R 3/00

(52) U.S. Cl. 16/2.1; 439/165

(57) ABSTRACT

A system for providing electrical conductivity through the hinge(s) of an electronic device without the use of individual conductive wires, flexible conductive cables, bundles of wire, discrete connectors, or combinations thereof is disclosed. A hinged member physically interconnects a movable body to a non-movable body of an electronic device, where at least one of the movable member and non-movable member includes three dimensional circuitry. The hinged member comprises electrically conductive material integrated therein and forming part of the hinge member. By use of this conductive material integrated within the hinged member, the hinged member provides electrical conductivity between the movable body and the non-movable body.

### TECHNICAL FIELD OF THE INVENTION

The present invention relates to portable electronic devices which require electrical connectivity of one or more connections through hinged members, or other rotating subassemblies. In particular, the present invention relates to a system of providing connectivity of electrical components, located in different parts of an electronic device, through a hinged member which provides both electrical and physical interconnectivity.

### BACKGROUND

Today, many electronic devices include two or more parts joined at a hinge, or other movable type of joint. Some common devices that use electrical connections through a hinge include, for example, portable computers, wireless telephones, personal digital assistants (“PDA”), camcorders, flip-out display devices, microphones, and cameras.

Conventionally, these devices require the use of a wire or set of wires through the hinge for electrical conductivity. This requires the physical routing of individual conductive wires, flexible conductive cables, electrical coaxial cable(s), bundles of wire, or combinations of these through the hinged area(s). This results in a difficult assembly process, multiple connections with associated reliability problems and assembly difficulties, severe space limitations, costs, limited control of desired electrical impedance and other electrical properties, poor removeability and serviceability, and mechanical considerations related to fatigue life due to the flexing of the electrical wires and conductors as the hinge is opened and closed repeatedly.

Thus, there is a need for a more reliable, and cost efficient solution to electrically connecting two or more portions of an electronic device through a hinge, or other movable part.

### SUMMARY OF THE INVENTION

The present invention is a system for providing electrical conductivity through a hinge between a movable body and a non-movable body of an electronic device. The hinge, or hinged member, physically and electrically interconnects the movable body to the non-movable body, where at least one of the movable member and the non-movable member includes three dimensional (“3-D”) circuitry. The hinged member comprises electrically conductive material integrated thereon and forming part of the hinged member. The electrically conductive material is integrated on the hinged member without the use of individual discrete, separate, conductive wires; flexible conductive cables; bundles of wire; or combinations thereof. Such integration is accomplished by 3-D circuit fabrication techniques such as film, photo-imaging, two-shot molding, and insert molding techniques. Alternatively, coaxial cable, or other controlled impedance low loss transmission line design; or conductive pins may be integrated on the hinged member. By integrating conductive material within the hinged member, the hinged member provides electrical conductivity between the movable body and the non-movable body, while physically interconnecting those two components of the electronic device.

In accordance with one embodiment of the present invention, the hinged (movable) member of the present invention may include slip rings integrated on the hinged member and contouring to the shape of the hinged member for establishing electrical contact through the hinged member. The slip rings establish direct electrical contact to the electrical circuits, parts, or components on the movable body, and sliding electrical contact with the electrical circuits, parts, or components on the non-movable body. The non-movable body may comprise stationary contacts, where each stationary contact is a complementary component of one slip ring thereby creating electrical conductivity. Alternatively, the slip rings may be included on the non-movable body and the stationary contacts may be included on the hinged member.

Further, in accordance with another embodiment of the present invention, the invention may provide a hinge pin integrally formed as part of the hinged member. A hinge pin is an electrically conductive rod or bar forming part of the hinge, that interconnects with a stationary contact(s) on the non-movable body.

In accordance with yet another embodiment of the present invention, the invention also may provide for high speed radio frequency (“RF”) connections through the hinged member. In this embodiment, the hinged member features a controlled impedance low loss transmission line design, preferably a coaxial connector insert integrated therein. Coaxial cable, connected to components in the movable member, is connected to the coaxial connector insert. The coaxial cable, by means of the coaxial connector insert, passes through the hinged member and electrically interconnects with a stationary contact(s) on the non-movable body.

3-D electrical circuit fabrication techniques may be utilized to integrate the electronic circuits on the movable body, to integrate the conductive material on the hinge, to integrate the electronic circuits on the non-movable body, and to interconnect the aforementioned circuits, connectors, and conductive material.

The hinged member of the present invention enables relative rotation of the movable body to occur while ensuring good electrical contact between the movable and non-movable bodies by providing electrical conductivity through the hinged member. The present invention permits a less expensive, easily assembled, reliable means of electrical connection and communication through increasingly small molded plastic electronic enclosures utilizing flips, lids, and other hinged or swiveling electronically interconnected subsystems on a various products.

### BRIEF DESCRIPTION OF THE DRAWINGS

Exemplary embodiments of the present invention will now be described in detail with reference to the accompanying drawings in which:

FIG. 1 is an illustration of a movable body and a non-movable body of an electronic device in accordance with a first embodiment of the present invention;

FIG. 2 is a detailed illustration of a second view of the hinged member of the electronic device of FIG. 1 in accordance with a first embodiment of the present invention;

FIG. 3 is a detailed illustration of the interior of a hinged member of the electronic device of FIG. 1, showing slip rings used for electrical connectivity between the movable body and non-movable body in accordance with a first embodiment of the present invention;

FIG. 4 is a detailed illustration of the electronic device of FIG. 1, showing contact fingers on the non-movable body used to interconnect with the slip rings to establish electrical conductivity between the movable body and non-movable body in accordance with a first embodiment of the present invention;

FIG. 5(a) is a detailed illustration of the electronic device of FIG. 3 showing the slip rings, used for electrical connectivity between the movable body and non-movable body, interconnected to 3-D electrical circuits routed and arranged on the surface of the molded plastic of the movable body in accordance with a first embodiment of the present invention;

FIG. 5(b) is a detailed illustration of the movable member of FIG. 5(a) showing a span underneath the slip rings in accordance with a first embodiment of the present invention;

FIG. 6(a) is a detailed illustration of the electronic device of FIG. 1 showing spring loaded contact fingers on a printed circuit board in the non-movable body and slip rings on the hinged member in accordance with a first embodiment of the present invention;

FIG. 6(b) is an illustration an alternative embodiment of the present invention, where the slip rings are integrated into the non-movable body and the contact fingers are integrated on the hinged member in accordance with a second embodiment of the present invention;

FIG. 7 is an illustration of a disassembled electronic device of FIG. 1 featuring contact fingers on a printed circuit board in the non-movable body, and slip rings on the hinged member in accordance with a first embodiment of the present invention;

FIG. 8 is an illustration of an electronic device featuring two conductive hinge pins for conductivity between a movable body and a non-movable body in accordance with a third embodiment of the present invention;

FIG. 9 is a detailed illustration of the hinge pin of FIG. 8 in accordance with a third embodiment of the present invention;

FIG. 10 is an illustration of a movable body and a non-movable body of an electronic device in accordance with a fourth embodiment of the present invention;

FIG. 11 is a detailed illustration of the hinged member and coaxial insert in accordance with a fourth embodiment of the present invention;

FIG. 12 is another detailed illustration of the hinged member and coaxial insert in accordance with a fourth embodiment of the present invention;

FIG. 13 is a detailed illustration of a two piece coaxial insert in accordance with the present invention; and

FIG. 14 is an illustration of a preferred embodiment of the present invention featuring a hinged member with slip rings on one side and a coaxial cavity on the other side.

### DETAILED DESCRIPTION OF THE INVENTION

The hinged member of the present invention provides integrated electrical conductivity between a movable body and non-movable body of an electronic device through the hinged member, without the use of individual conductive wires, flexible conductive cables, electrical coaxial cable(s), bundles of wire, or combinations thereof.

The hinged member physically and electrically interconnects a movable body to a non-movable body of an electronic device. The hinged member comprises electrically conductive material integrated thereon and forming part of the hinge member. By use of this conductive material integrated within the hinged member, the hinged member provides electrical conductivity between the movable body and the non-movable body.

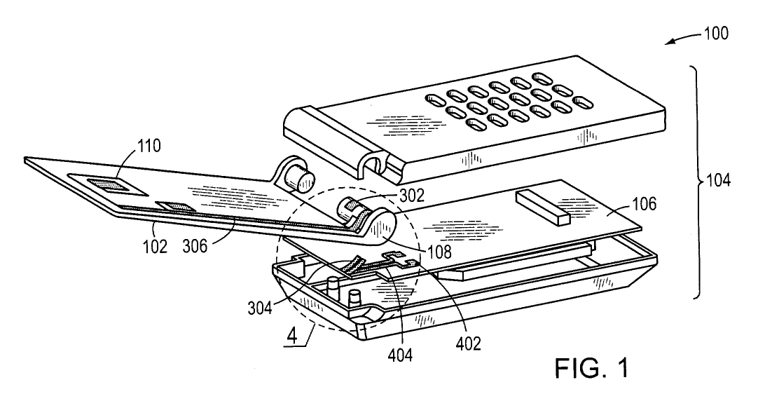

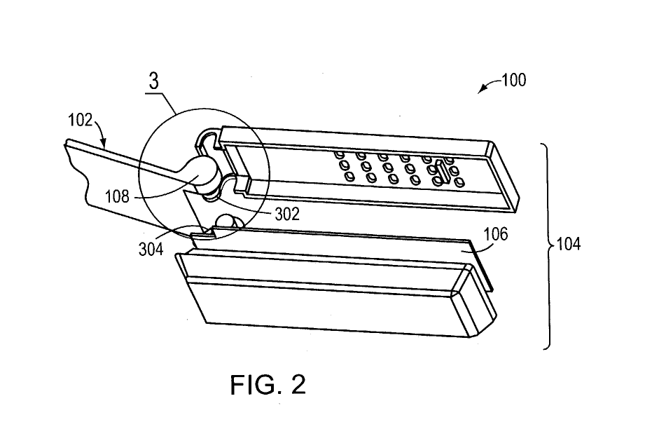

A wireless telephone device is used as a representative electronic device in the description below solely for simplicity of explanation, and is not intended to limit the scope of the invention. Referring to the drawings, FIG. 1 illustrates a wireless telephone (an electronic device) 100 featuring a movable body 102 and non-movable body 104. Movable body 102 and non-movable body 104 are interconnected by a hinged member 108. Movable body 102 includes one or more electronic circuits 110, or other electrical parts or features, e.g., an antenna. (FIG. 2 provides a depiction of FIG. 1 from a different perspective.)

Electronic circuits 10 are fabricated directly on the substrate of the movable body 102 using any methods of fabricating 3-D circuits on a substrate, e.g. a plastic substrate. Such techniques include “applique” film techniques, photo-imaging, two-shot molding, or insert molding, and are described in detail below. These techniques are also employed to integrate the electrically conductive material on the hinged member and to interconnect the electronic circuits on the movable and non-movable bodies through the hinge. Non-movable body 104 includes a printed circuit board 106 on which electronic circuits reside. Electrical circuits on the non-movable body may also be integrated thereon by the aforementioned 3-D circuit fabrication techniques.

The insert molding process uses conductive wires, stamped metal pieces, etc. that are placed into the mold and captured by the injection molding process. The film techniques, photo imaging and two-shot molding manufacturing processes are described on (a) the MIDIA Homepage http://www.midia.org/mida2.htm, at “Manufacturing Process Descriptions,” accessed on Jun. 20, 2002, the entirety of which is incorporated herein by reference and (b) the Siemens Website R&D Homepage http://w4.siemens.deFuI/en/archiv/zeitschrift/helft1₁₃ 97/artike/10/index.html at “Manufacturing Technology,” accessed on Jul. 1, 2002, the entirety of which is incorporated herein by reference.

Film techniques have in common the fact that the conducting material starts out as a separate, flexible film, and then is subsequently attached to an injection-molded plastic substrate. The conductors are normally formed from copper laminate, foil, or silver conductive inks on a carrier. Common film techniques are the capture process, transfer process, and hot stamping.

The capture process utilizes pre-formed circuits on a flexible carrier which are then inserted into an injection mold. The circuits are formed by either printing conductive inks, or by selectivity etching copper-clad films. The circuit on the flexible carrier is die-cut to shape, and can be thermoformed into three dimensions before inserting it in the mold. During the molding cycle, the plastic resin is injected behind the carrier, forcing it against the outer surfaces of the mold. After the cycle is complete, the carrier with the circuit becomes an integral portion of the rigid injection-molded part. Metal-plating may be used to build up circuit thickness or provide a different metal overcoat. The circuits on the carrier can be either single or double-sided. Circuits for the capture process can either be one-sided or two sided, and can be flat or thermoformed into a three-dimensional shape.

The transfer process is a slightly different variation of the capture process. In the transfer process the flexible carrier is peeled away rather than remaining with the molded part, leaving only the circuits. In this case, the top of the circuits end up flush with the surface of the molded part which may have benefits for applications requiring sliding contacts. Only single sided circuits on the carrier can be used in this process.

Hot stamping is another common film technique which utilizes flexible copper foil coated with an adhesive, along with embossing and hot-stamping. A special embossing die is built incorporating a heated block. In this method the substrate is injection-molded prior to applying the circuit. The foil is pressed onto the plastic using the heated die and at the same time, the conductor is cut off in the shape of the embossing die to form the circuit. The remaining foil is then removed. Copper foil with other metal overcoats may be used. This is a relatively simple process, but the plastic surface where the circuit is being embossed must be relatively flat, or have a smooth, uniform contour so that the embossing die can contact the surface precisely.

As alternatives to film techniques to form 3-D circuits, photo-imaging processes use some form of light energy to define the circuits, and in most cases, an etching process to remove unwanted metal after imaging. Common photo-imaging techniques include 3-D masking, which is Applicant's preferred technique, and direct laser marking.

3-D Masking utilizes a photoresist coated onto the conductor which is then exposed to ultraviolet light through a mask. The substrate is first chemically treated in order to promote adhesion between the plastic and metal which will be plated onto it. A thin layer of copper is deposited which makes the surface conductive, followed by the application of a photoresist. The substrate is then placed into a photomask and exposed to ultraviolet light. The photomask has been designed to allow light to expose and harden the photoresist everywhere except where the circuit pattern is desired. These three-dimensional masks can be produced by machining metal or plastic, or by utilizing a process whereby a laser, controlled by a robot, creates an image on a special laser markable plastic. This plastic sheet is vacuum-formed to create the three-dimensional mask. After ultraviolet light exposure, the unhardened resist is chemically removed, leaving the underlying copper uncovered where the circuit traces are required. Copper is then electroplated to build up the desired thickness of the circuit, followed by another metal overcoat, if desired. All photoresist is then chemically removed, followed by the etching away of the thin layer of electroless copper. This leaves the plastic part with only the desired circuit pattern. This plating process is described as “semi-additive.”

There is a variation of the 3-D masking process which uses fully additive plating techniques. In this technique, the entire plastic substrate is plated with copper to the final desired thickness before the resist is applied. The photomask is designed so that the resist is exposed and hardened where the circuit traces are desired. After the unhardened resist is chemically removed, the entire thickness of copper which has been uncovered is etched away, again leaving the plastic part with only the desired circuit pattern. With this method, however, the copper traces are still coated with the hardened resist. This is chemically removed, and then electroless metal or organic overcoats can be applied. This process is described as “subtractive” processing.

Direct laser marking is another common photo-imaging technique which uses a laser beam controlled by a robot to image the pattern on the metal plated plastic part directly without the use of a mask. With this method, the entire part is plated with copper to the final desired thickness, followed by a thin layer of tin which acts as a resist to certain etchants. The laser is then used to create the image outline of the circuit paths by removing or ablating the thin layer of tin from the copper. The underlying copper is then etched away which isolates the circuit traces defined by the laser. This process generally leaves most of the non-circuit plastic surface covered with metal which can be useful for EMI/RFI shielding, e.g., antennas.

A third common technique for 3-D circuit formation is two-shot molding. Two-shot molding techniques use two separate molding cycles, and usually two different plastic resins to form the part. (This type of molding is sometimes referred to as two-color or two-component molding.) This technique requires construction of different complementary mold cavities for each shot. Common two-shot molding techniques include a catalyzed resin process, a non-catalyzed process, and a two part assembly process.

The catalyzed resin process uses a plastic resin which contains a small percentage of plating catalyst. The part is designed so that the imaging is done during the molding by leaving this catalyzed resin exposed on the surface of the final part only where the circuit traces are desired. This is accomplished by creating two molds. The first shot is molded, and then inserted into the second mold. The second resin then forms the final three-dimensional features of the part. Depending on the design of the part, either the first or second shot resin may be the one containing the plating catalyst. After molding the second shot, the part is chemically treated in order to promote adhesion between the plastic and the metal which will be plated onto it. When the part is run through an electroless copper plating cycle, only the resin which contains the catalyst accepts plating and thus creates the circuit pattern. Other electroless metal overcoats can be applied if desired. Rotary molds or robotic handling may be used for the two shot molding process.

The non catalyzed process uses resins which do not contain a plating catalyst. In this technique, the first shot is molded, and then chemically treated with a catalyst before molding the second shot. The completed part is then run through the copper plating cycle, and only the resin which has been chemically treated plates to form the circuits.

Alternatively, the two part assembly process is yet another variation in which two separate parts may be molded. In this method, one part is plated in its entirety with copper, and any desired overcoats. This part is then mechanically assembled with the other non-plated second part to form the final part configuration.

Insert molded circuits are formed by using stamped or formed or die-cut conductors. The conductors are placed into features in a mold tool that is then filled with injected plastic, capturing and locating the conductors while leaving the desired portions of the conductors exposed or protruding on the surface of the molded part.

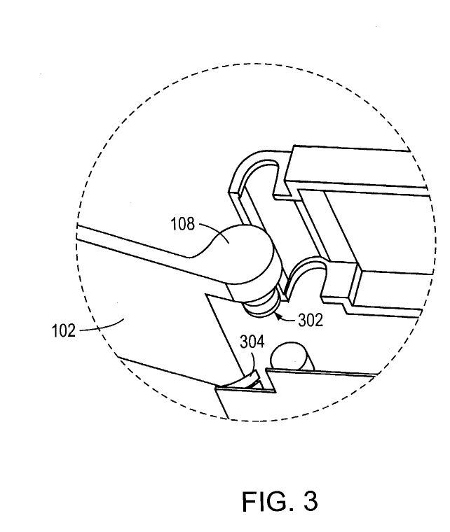

Referring to FIG. 1 and FIG. 3, electronic circuits 110 on the movable body 102 are directly interconnected to one or more slip rings 302, on a hinged member 108 of the movable body 102, by electrically conductive lines 306 formed onto the inner surface of the movable body 102 using any of the above described 3-D circuit fabrication techniques. These electrically conductive lines 306 are formed in the molded plastic of the movable body 102 to interconnect or communicate electrical signals from the electronic circuits 110 located elsewhere on the movable body 102 to the conductive slip-rings 302 or visa versa.

The slip rings 302 allow for free relative rotation of the hinged member 108, while also ensuring good electrical contact and communication between the circuitry located in both molded plastic bodies 102, 104. The metal or metal plated plastic slip rings 302 are formed using electrically conductive material(s), well known to those in the art, to enable easy installation, ensure good wear characteristics and overall excellent electrical connection properties with low resistance and low noise. The slip rings 302 can be comprised of, or plated with, copper, beryllium/copper alloys, nickel, gold, or any other conductive metal. In choosing a conductive material, the slip rings 302 and underlying molded plastic materials can, if needed, be optimized for electrical impedance control. Electrical impedance control is especially important for applications using high frequency or RF currents through the hinged areas 108.

The slip rings 302 can be stamped or plated metal conductors that can be snapped into place on the hinged member 108, such that the slip rings 302 are either on the surface of the hinged member 108 or recessed in the hinged member 108, and integrated into hinged member 108, conforming to the contours of the hinged member 108. Alternatively, the slip rings 302 may be fabricated on the hinged member 108 employing any of the above described 3-D circuit fabrication techniques. In a preferred embodiment of the present invention, each slip ring 302 has a metal thickness ranging from 0.0001 to 0.010 inches.

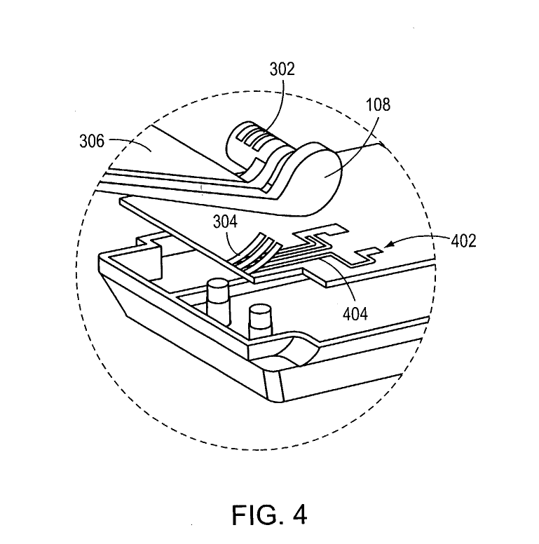

The slip rings 302 mate with, or align with, and brush against stationary contacts shown as contact fingers 304 on the non-movable body 104. See FIG. 4. In a preferred embodiment, the contact fingers 304 are spring loaded conductive bodies and physically located on the printed circuit board 106 of the non-movable body 104, as shown in FIGS. 1, 4 and 6(a), such that the contact fingers 304 are electrically connected to the circuits 402 on the printed circuit board 106 via electrical lines 404. The contact fingers 304 may be provided in a wide variety of shapes, sizes and configurations. The contact fingers 304 may be formed by stamping or plating metal conductors that can be affixed mechanically and electrically to the printed circuit board 106. Alternatively, the contact fingers 304 may be recessed in the base substrate of the non-movable body 104, using any of the above described 3-D circuit fabrication techniques, where the complementary slip rings 302, in this case, are spring loaded (while still conforming to the shape of the hinged member 108). The contact fingers 304 may be comprised of, or plated with, copper, beryllium/copper alloys, nickel, gold, or any other conductive metal, and each preferably have thickness ranging from 0.001 to 0.040 inches.

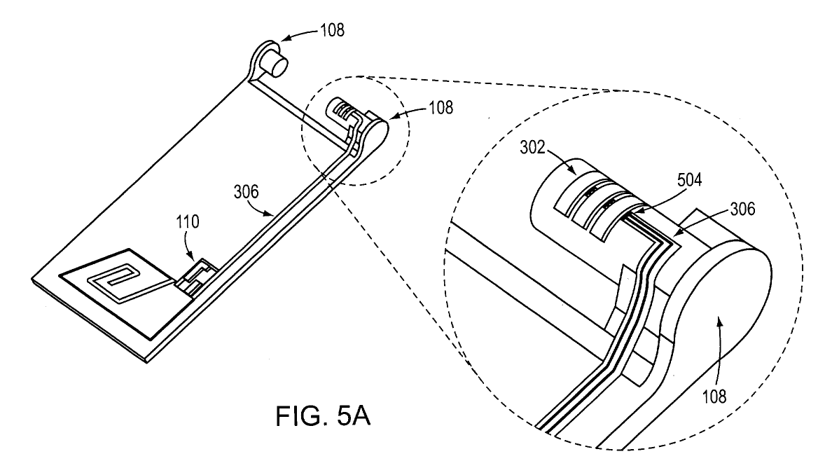

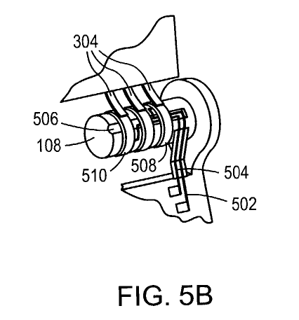

Referring to FIG. 5(a), the slip rings 302 are electronically connected to electrically conductive lines 306 (patterned using any of the 3-D circuit fabrication techniques described above). As shown in FIG. 5(b), the electrically conductive lines 502, 504 may selectively pass under a span 506, a molded recessed cavity under the slip rings 508, 510 and interconnect with a slip ring(s) of choice. For example, in FIG. 5(b) electrically conductive line 502 interconnects with slip ring 508, and electrically conductive line 504 interconnects with slip ring 510. Alternatively, the electrically conductive lines 502, 504 and the slip rings 508, 510 may be the same continuous materials, respectively, if the slip rings 508, 510 are fabricated and recessed in the hinged member 108 are described above. However, such an approach may be more costly.

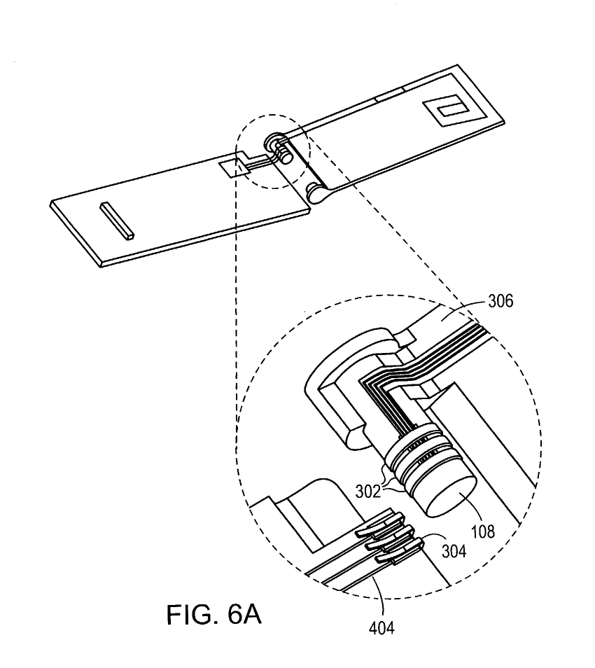

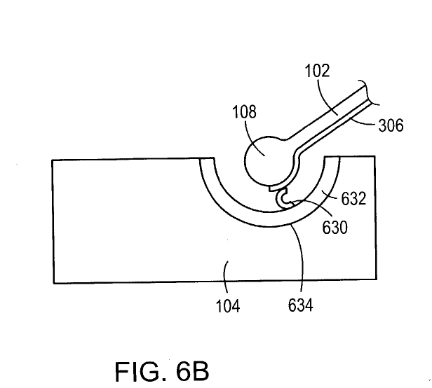

Referring to FIG. 6(b), in another alternative (second) embodiment, the contact fingers 630 may be integrated on the hinged member 108, and the slip rings 632 may be integrated in non-movable body 104, where non-movable body 104 features a recessed cavity 634.

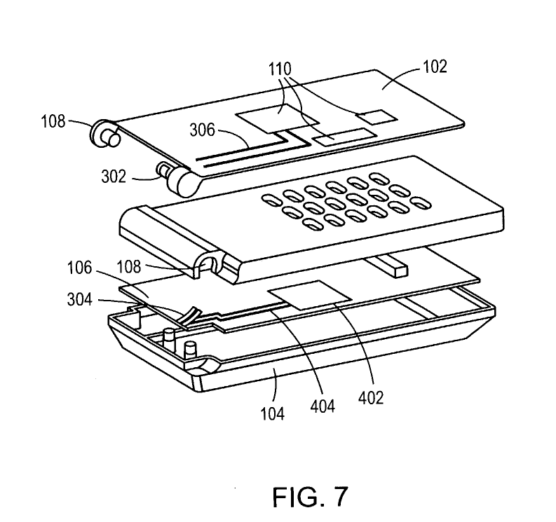

FIG. 7 provides an illustration of all of the above-described members and parts of wireless telephone 100. In particular, FIG. 7 shows the ease of connectivity of wireless telephone 100 utilizing the inventive features of the present invention. Typically the constituent bodies simply snap or press-fit together, thereby automatically electrically engaging the movable body 102 with the non-movable body 104 through the hinged member 108.

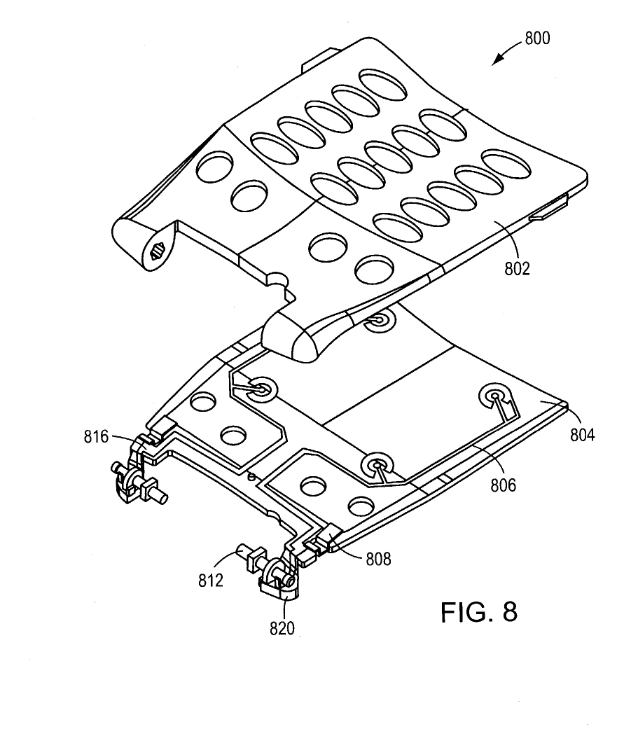

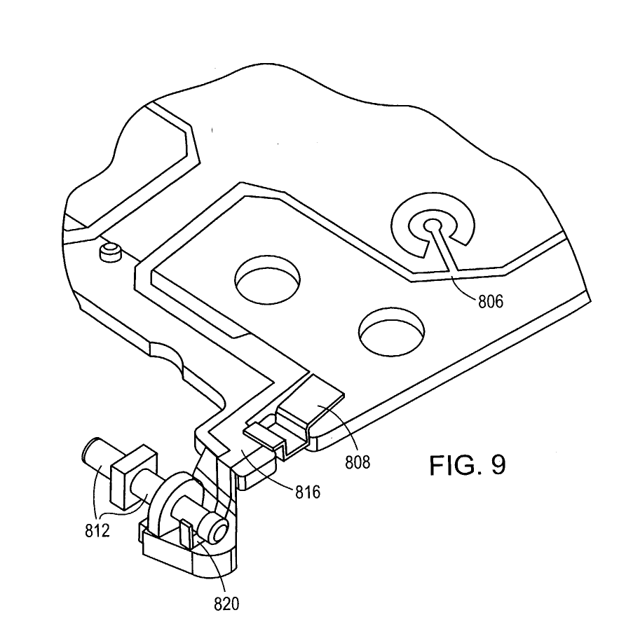

Referring to FIG. 8, as an alternative to utilizing slip rings 302, in a third preferred embodiment of the present invention, a hinge pin 812 may be used. A hinge pin 812 is most useful for applications where few electrical connections, e.g., two connections, between a movable body and a non-movable body are needed. An example of such would be a wireless flip telephone where a 2-wire microphone needs to communicate to a non-movable body. (Also see open/close contact 808.) FIG. 9 illustrates a close-up of the hinge pin 812, which interfaces with a stationary contact on a non-movable body. A hinge pin 812 may be comprised of, or plated with copper, nickel, gold, or any other conductive metal. A stationary contact to mate with the hinge pin 812 may be a contact finger or cylindrical conductive body with an inner void whereby the hinge pin 812 interfaces, or equivalent feature to receive hinge pin 812, mounted on a printed circuit board in a non-movable body.

Referring back to FIG. 8, a movable body assembly 800 of an electronic device is illustrated. Movable body assembly 800 includes a keypad member 802, and flip inner housing 804. Keypad member 802 typically contains a numeric membrane keypad for a user to dial in a number (numeric membrane not shown). Typically the numeric membrane keypad interfaces with a flexible circuit used to discern and communicate numbers corresponding to those pressed by a user on the numeric membrane keypad. A flexible circuit is typically used for this application because a flexible circuit provides a surface where wires can be soldered. Additionally, wires on the flexible circuit keypad or discrete wires, cable and connector(s) are generally needed to pass through the hinge to interconnect with circuits in a non-movable body. However, utilizing the inventive features of the present invention the flexible circuit, wires, cable, or connector(s) can be eliminated, as shown in FIG. 8. This is primarily because a flexible circuit was only needed because of the need for wiring for the conventional interconnection through the hinge. Using the slip rings 304 or hinge pin 812 as shown in this second embodiment of the present invention, the flexible circuit can be replaced with a keypad circuit 806 molded or formed/patterned directly on the substrate, where the circuit on the substrate interconnects with the slip rings 304 or hinge pin 812 via electrically conductive lines 816, similar to that of FIG. 5(b).

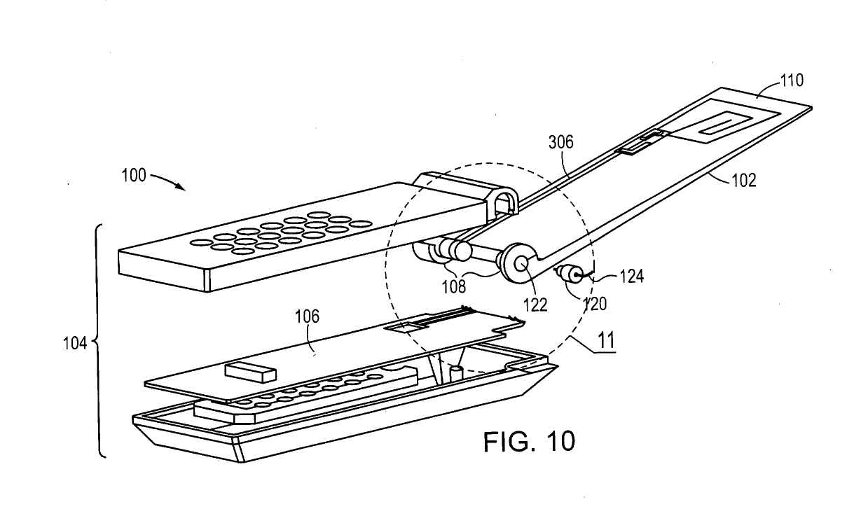

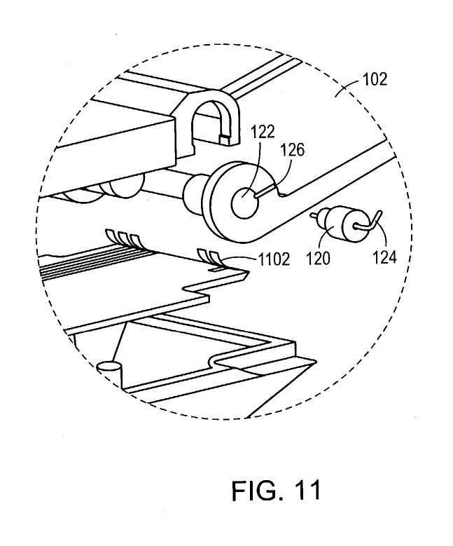

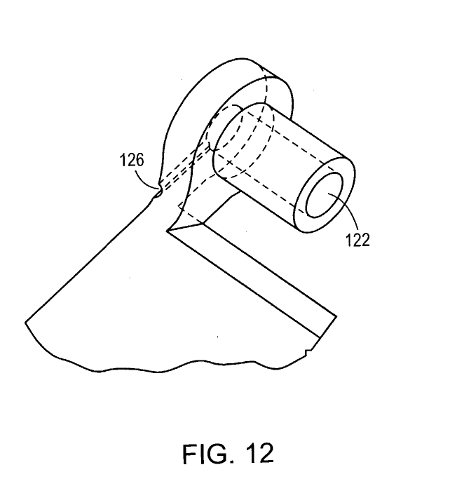

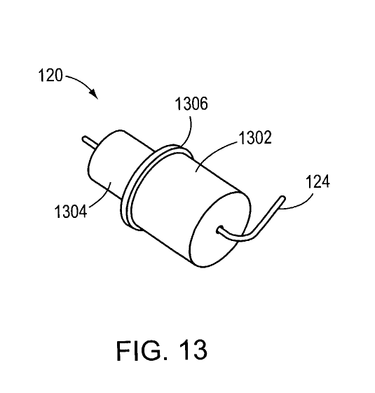

Referring to FIG. 10, in accordance with a fourth embodiment of the present invention, coaxial cable 124, or other controlled impedance low loss transmission line design, e.g., striplines, is passed through the hinged member 108, thereby establishing high speed RF coaxial connections though the hinged member 108 for purposes of controlled impedance in high frequency applications. The hinged member 108 features a coaxial insert 120 mountable in the hinged member 108. Referring to FIG. 11, the coaxial insert 120 is constructed to securely hold coaxial cable 124 therein. The coaxial insert 120 fits into a cavity 122 in the hinged member 108, as shown in FIG. 12. Preferably the coaxial cable insert 120 is a one piece assembly, where coaxial cable 124 passes through the coaxial insert 120 and along a coaxial feed 126 on the hinged member 108 to maintain electrical contact with desired components on the movable member 102. The other end of the coaxial cable 124 interconnects with a second set of stationary contacts 1102 (of FIG. 11) (similar to stationary contacts 304, described above) to provide electrical conductivity between the components in the movable member 102 and the non-movable member 104. Alternatively, as shown in FIG. 13 the coaxial insert 120 may be constructed as two pieces which mate at a rotatable interconnection 1306, where one piece 1302 of the coaxial insert 120 maintains stationary contact with the hinged member 108, and another piece 1304 of the coaxial insert 120 maintains stationary contact with the non-movable member 104. Alternative to using the coaxial insert 120, the features of the coaxial insert 122 may be molded directly into the hinged member 108.

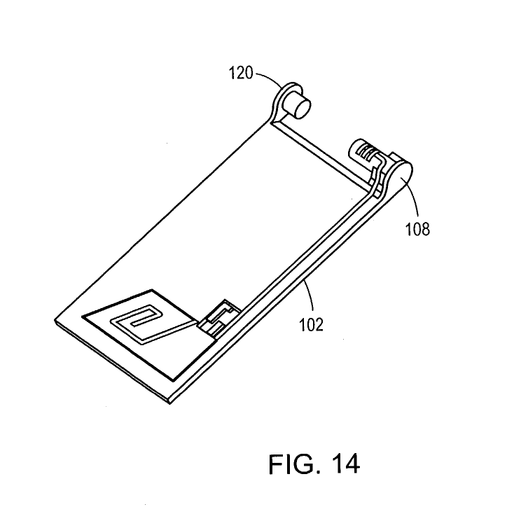

Preferably, as shown in FIG. 14, the above embodiments may be combined such that one side of a hinged member 108 may feature slip rings 302 and the other side of the hinged member 108 may feature a coaxial cavity 122 for insertion of a coaxial insert 120.

The resultant rotating connection system of the present invention results in products with hinged members that are cheaper, more easily assembled and serviced, more reliable, easily produced and replicated in high volumes, and do not require separate wiring, cables, connectors, or other means to establish electrical connection and communication through the hinged members.

Although the present invention has been described in detail with reference to specific exemplary embodiments thereof, various modifications, alterations and adaptations may be made by those skilled in the art without departing from the spirit and scope of the invention.

We claim:

1. A system for providing electrical connectivity through a hinge, said system comprising:
a movable body, said movable body including electrically conductive material;
a non-movable body, said non-movable body including electrically conductive material; and
a hinged member physically interconnecting said movable body to said non-movable body, said hinged member comprising electrically conductive material integrated thereon and forming part of said hinged member; said hinged member providing electrical conductivity between said movable body and said non-movable body through said hinged member, wherein at least one of said movable member and said non-movable member includes three dimensional circuitry.

2. The system of claim 1 wherein said hinged member comprises at least one slip ring mounted on said hinged member, said ring having electrically conductive properties.

3. The system of claim 1 wherein said non-movable member comprises at least one slip ring mounted integrally onto said non-movable member, said ring having electrically conductive properties.

4. The system of claims 2 or 3, wherein said ring comprises a material selected from the group consisting of copper, gold, nickel, beryllium, and alloys thereof.

5. The system of claims 2 or 3, wherein said ring has a thickness ranging from 0.0001 to 0.010 inches.

6. The system of claim 2 wherein said ring contours to the shape of said hinged member and is integrally part of said hinged member.

7. The system of claim 3 wherein said ring contours to the shape of a recessed cavity in said non-movable body and is integrally part of said non-movable body.

8. The system of claim 2 wherein said ring is recessed within said hinged member.

9. The system of claim 2 wherein said ring is spring loaded on said hinged member.

10. The system of claim 3 wherein said ring is spring loaded on said non-movable member.

11. The system of claim 2 wherein said ring is insert molded on said hinged member.

12. The system of claim 3 wherein said ring is insert molded on said non-movable member.

13. The system of claim 2 wherein said non-moveable body comprises at least one stationary contact, said contact having electrically conductive properties, and said contact maintaining an electrical interconnection with said ring provided through said hinged member.

14. The system of claim 3 wherein said hinged member comprises at least one stationary contact, said contact having electrically conductive properties, and said contact maintaining an electrical interconnection with said ring provided through said hinged member.

15. The system of claims 13 or 14, wherein said hinged member comprises a molded recessed span beneath said ring, said span allowing electrically conductive lines to pass, without contact, under one or more of other slip rings, while establishing electrical contact with another slip ring.

16. The system of claims 13 or 14, wherein said stationary contact comprises at least one contact finger.

17. The system of claims 13 or 14, wherein said stationary contact comprises a material selected from the group consisting of copper, gold, nickel, beryllium, and alloys thereof.

18. The system of claims 13 or 14, wherein said stationary contact has a thickness ranging from 0.001 to 0.04 inches.

19. The system of claim 13 wherein said stationary contact is mounted on a printed circuit board residing on said non-movable body.

20. The system of claim 13 wherein said stationary contact is spring loaded on a printed circuit board residing on said non-movable body.

21. The system of claim 13 wherein said stationary contact is mounted on a surface of said non-movable body.

22. The system of claim 13 wherein said stationary contact is recessed within said non-movable body.

23. The system of claim 13 wherein said stationary contact is insert molded onto said non-movable body.

24. The system of claim 1 wherein said hinged member comprises a hinge pin, said pin having electrically conductive properties.

25. The system of claim 24, wherein said pin comprises a material selected from the group consisting of copper, gold, nickel, beryllium, and alloys thereof.

26. The system of claim 1 wherein said hinged member comprises a coaxial insert, said coaxial insert allowing coaxial cable to pass therein.

27. The system of claim 26 wherein said coaxial insert is fitted into a coaxial cavity in said hinged member.

28. The system of claim 26 wherein said coaxial insert comprises two pieces which interconnect and provide relative rotation between said two pieces.

29. The system of claim 1 wherein said hinged member comprises a controlled impedance low loss transmission line.
